(19) United States
(12) Patent Application Publication
(10) Pub. No.: US 2010/0092906 A1
(43) Pub. Date: Apr. 15, 2010

(54) CORRECTOR ASSEMBLY WITH A TELESCOPABLE PORTION, A CRIMPABLE PORTION, AND AN ENGAGING PORTION, AND A RELATED METHOD

(75) Inventors: Jefferson Sabilla, Ontario, CA (US); John Warren Graham, Phoenix, AZ (US)

Correspondence Address: WOOD, HERRON & EVANS, LLP, 2700 CAREW TOWER, 441 VINE STREET, CINCINNATI, OH, 45202, US

(73) Assignee: ORMCO CORPORATION, Orange, CA (US)

(21) Appl. No.: 12/444,701

(22) PCT Filed: Oct. 10, 2007
(86) PCT No.: PCT/US07/80891

§ 371 Date: Dec. 22, 2009

Related U.S. Application Data
(60) Provisional application No. 60/850,624, filed on Oct. 10, 2006.

(51) Int. Cl. A61C 7/00

(52) U.S. Cl. 433/20; 433/18; 433/21

(57) ABSTRACT

A method, an orthodontic system, and orthodontic assembly (10), and a corrector assembly (8) with a telescopable portion (19), an attachable portion (18), and an engaging portion (20). The attachable portion (18) is attached to the telescopable portion (19) and is configured for coupling to a corrective device (14). The engaging portion (20) is attached to the telescopable portion (19) and is configured for coupling to an orthodontic implant (44). The telescopable portion (19) may be configured for pivotally coupling to the engaging portion (20). The attachable portion (18) may be configured for coupling to a corrective device (14), such as by crimping. The engaging portion (20) may be configured for rotatably coupling to an orthodontic implant (44). A process for attaching the corrector assembly (8) is provided by the method. By having a telescopable portion (19), an attachable portion (18), and an engaging portion (20), multiple modes of adjustability and direction of movement are possible.

### PRIORITY CLAIM

This application claims the benefit of U.S. Provisional Patent Application Ser. No. 60/850,624, filed Oct. 10, 2006 and entitled “Orthodontic Devices, Implants and Related Apparatus,” the disclosures of which are expressly incorporated by reference herein in their entirety.

### TECHNICAL FIELD

This invention generally relates to orthodontic systems and, more particularly, to occlusion corrector assemblies.

### BACKGROUND

Orthodontic devices address different types of problems in a patient's mouth, such as improving a patient's occlusion. In conventional orthodontic treatments, an orthodontist or an assistant affixes brackets or the like to the patient's teeth and engages a corrective device such as a wire or a spring into a slot of each bracket. The wire applies corrective forces that coerce the teeth to move into correct positions.

Known orthodontic devices may also include implants such as screws, which are fixed to a structure in the patient's mouth. Corrective devices such as wires or springs are then coupled to the implants such that a corrective force can be applied to teeth. However, the range of motion of known orthodontic devices is often limited. As a result, a longer period of time may be required to coerce the teeth to move into correct positions, often increasing the costs to patients.

### SUMMARY

The invention addresses these and other problems associated with the prior art by providing a method, an orthodontic system, an orthodontic assembly, and a corrector assembly with a telescopable portion, a crimpable portion, and an engaging portion. The crimpable portion is attached to the telescopable portion and is configured for coupling to a corrective device. The engaging portion is attached to the telescopable portion and is configured for coupling to an orthodontic implant.

Consistent with the invention, the telescopable portion may be configured for pivotally coupling to the engaging portion. The crimpable portion may be configured for coupling to a corrective device such as a wire or a slot member (e.g., orthodontic bracket) and may be configured to telescope in response to an action causing the telescopable portion to telescope. At least a part of the crimpable portion may be a spring or a wire. The crimpable portion may also have a head structure at a distal end of a wire configured for crimpably coupling to the corrective device. The engaging portion may be an orthodontic overcap or an orthodontic eyelet and may be configured for rotatably coupling to an orthodontic implant, such as an orthodontic screw. Orthodontic implants suitable for use in connection with the corrector assembly of the present invention are disclosed in co-pending PCT International application Ser. No. ______, filed Oct. 10, 2007, entitled “Orthodontic Implants,” which is expressly incorporated by reference herein in its entirety.

In another embodiment, the orthodontic assembly may include an orthodontic implant and a corrector assembly. The corrector assembly may include a telescopable portion, a crimpable portion attached to the telescopable portion and configured for coupling to a corrective device, and an engaging portion attached to the telescopable portion and coupled to the orthodontic implant.

In another embodiment, an orthodontic system may include a corrective device, an orthodontic implant, and a corrector assembly. The corrector assembly may include a telescopable portion, a crimpable portion attached to the telescopable portion and coupled to the corrective device, and an engaging portion attached to the telescopable portion and coupled to the orthodontic implant.

In another embodiment, a method of attaching a corrector assembly for applying a corrective force into a tooth may include implanting at least a portion of an orthodontic implant into a mouth, attaching at least one corrective device to the mouth, coupling the engaging portion to at least a portion of the orthodontic implant, and coupling the crimpable portion to the corrective device. Furthermore, the corrector assembly has a telescopable portion, a crimpable portion configured to be attached to the telescopable portion, and an engaging portion configured to be attached to the telescopable portion.

Those of ordinary skill in the art may appreciate that by having a telescopable portion, a crimpable portion, and an engaging portion, multiple modes of adjustability and direction of movement are possible. This and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there are described exemplary embodiments of the invention.

### BRIEF DESCRIPTION OF THE DRAWINGS

Various additional features and aspects will become readily apparent to those of ordinary skill in the art from the following description of illustrative embodiments of the invention and from the drawings in which:

FIG. 1 is a perspective view of an embodiment of a corrector assembly, an orthodontic implant, and a corrective device; and

FIG. 2 is a cross-sectional view of the corrector assembly, the orthodontic implant, and the corrective device of FIG. 1.

FIG. 2A is an elevation view of the engaging portion of FIGS. 1 and 2 prior to a clockwise rotation of an overcap that is coupled to a screw.

FIG. 2B is an elevation view of the engaging portion of FIGS. 1 and 2 after a clockwise rotation of the overcap that is coupled to the screw.

### DETAILED DESCRIPTION

Although the invention will be described next in connection with certain embodiments, the invention is not limited to practice in any one specific type of orthodontic system. The description of the embodiments of the invention is intended to cover all alternatives, modifications, and equivalent arrangements as may be included within the spirit and scope of the invention as defined by the appended claims. In particular, those skilled in the art will recognize that the components of the embodiments of the invention described herein could be configured in multiple different ways.

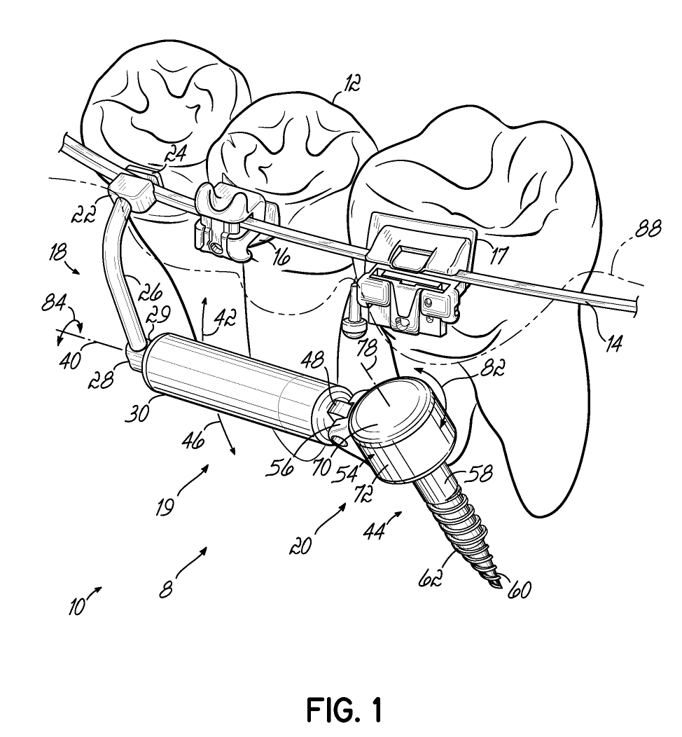

Referring now to FIG. 1, an orthodontic system 10 includes a corrector assembly 8 coupled to a corrective device 14 and an orthodontic implant 44. The corrector assembly 8 includes a crimpable portion 18, a telescopable portion 19, and an engaging portion 20. In particular, the crimpable portion 18 permits coupling of the corrector assembly 8 to the wire 14, while the engaging portion 20 permits coupling of the corrector assembly to the orthodontic screw 44. Although in the figures the corrective device is in the form of a wire 14, this is only for illustrative purposes since the corrective device may alternatively take other forms, such as a slot member (e.g., bracket) and the like. Furthermore, the figures depict an orthodontic implant in the form of an orthodontic screw 44, although other forms of implants are similarly contemplated.

Turning first to the crimpable portion 18 and corrective device 14, the crimpable portion 18 is illustrated as having a wire 26 with head structures 22 and 24. Wire 26 is generally a bendable wire. Wire 26 is attached to the distal end of piston rod 28, which is located within piston housing 30 of telescopable portion 19. Head structures 22 and 24 have a generally rectangular shape and a cavity between head structure 22 and head structure 24 holds wire 14. Head structures 22 and 24 are attached to the distal end of wire 26. Wire 14 may be an archwire or other orthodontic wire and is suspended via brackets 16 and 17, which are attached to teeth 12. Bracket designs different than those illustrated may also be utilized to suspend wire 14.

Head structure 22 and/or head structure 24 are bendable about a region of coupling of wire 14, thereby permitting crimping of head structure 22 and/or head structure 24, while leaving the shape of wire 14 substantially intact. After crimping, head structures 22 and/or 24 of crimpable portion 18 may be in a locking engagement with wire 14. Virtually any technique for crimping in the field of orthodontics may be utilized to crimp head structure 22 and/or head structure 24. While in this embodiment, crimping may deform head structure 22 and/or head structure 24, those of ordinary skill in the art will readily appreciate that a variety of variations than those depicted are contemplated. For example, in some embodiments crimping may additionally deform the wire, crimping may only deform the wire, etc.

As illustrated in FIG. 1, crimpable portion 18 may also travel along axis 40 in response to an action causing piston rod 28 of telescopable portion 19 to travel along axis 40 or telescope along axis 40. Practically any pushing or pulling force generated during the orthodontic correction process may cause piston rod 28 to telescope along axis 40, which in turn may cause crimpable portion 18 to telescope along axis 40. Such forces may even come from crimpable portion 18 when the type of wire 14 is conducive to self guiding.

Those of ordinary skill in the art may appreciate that although crimpable portion 18 is depicted as a wire 26 with head structures 22 and 24 in FIG. 1, practically any head structure or structures capable of crimpably attaching to a corrective device such as wire 14 or a slot member such as brackets 16 and 17 may be utilized. Furthermore, those of ordinary skill in the art may appreciate that crimpable portion 18 may be a spring, spring-like device, or the like that is capable of crimpably attaching to a corrective device such as wire 14. Head structure 22 and 24 may be utilized in combination with a spring or spring-like device or they may be dispensed with altogether. In this configuration, crimpable portion 18 would primarily comprise a spring or spring-like device.

Similarly, those of ordinary skill in the art will readily appreciate that other mechanisms and/or fasteners may be utilized to attach crimpable portion 18 and telescopable portion 19. For example, although wire 26 and piston rod 28 are shown as one structure, wire 26 and piston rod 28 may be two separate structures in another embodiment.

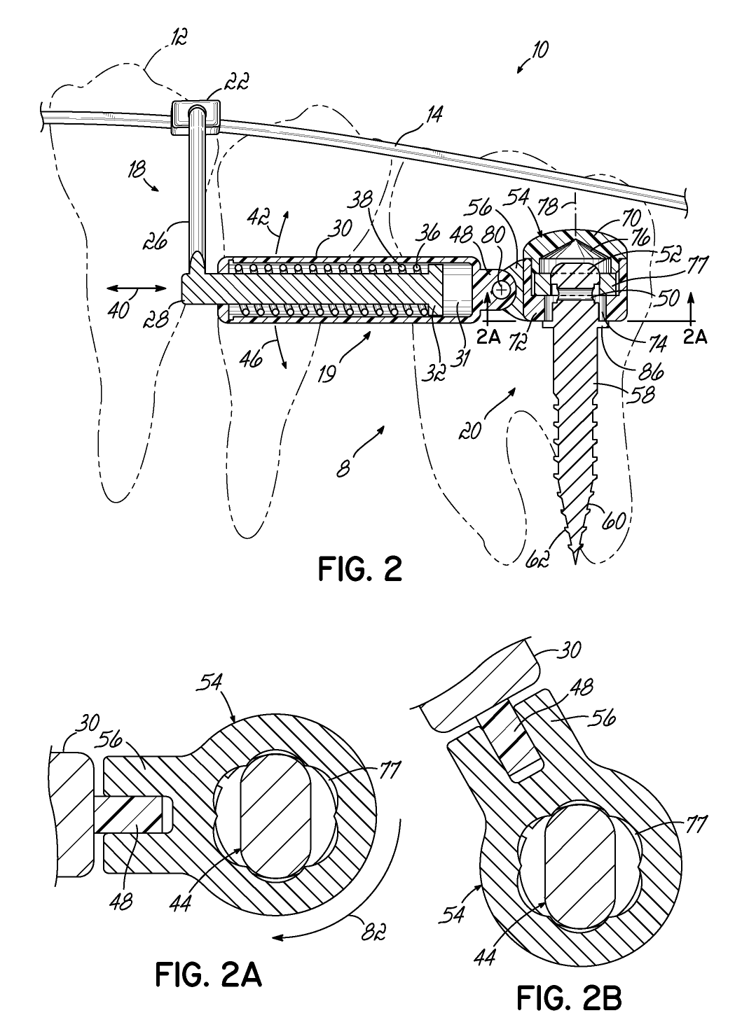

Telescopable portion 19 of corrector assembly 8 is depicted as a piston with a piston housing 30, a piston rod 28, and a connector member 48. Piston housing 30 is cylindrical in shape and contains a plurality of movement restricting members 36 and 38 (shown in FIG. 2) that control the movement of piston rod 28. Piston housing 30 also has an opening 29 to allow piston rod 28 to slidably travel in and out of piston housing 30 along axis 40 according to the configuration of the movement restricting members 36 and 38. Piston rod 28 travels along axis 40 in response to pulling or pushing forces that occur during the orthodontic corrective process. Additionally, piston rod 28 may swivel within piston housing 30. Arrows 84 illustrate the swivel.

Piston housing 30 also contains a connector member 48 to attach to engaging portion 20 and vice versa. In particular, connector member 48 is secured to connector member 48 of engaging portion 20 via a screw 80 (shown in FIG. 2) that keeps connector member 48 and connector member 48 in a locking engagement. This locking engagement allows piston housing 30 to pivot relative to engaging portion 20, and as a result, telescopable portion 19 may be configured to pivotally couple with the engaging portion 20. A force causing an upward pivot may be illustrated by arrow 42 and a force causing a downward pivot may be illustrated by arrow 46.

Although the attachment of telescopable portion 19 and engaging portion 20 is illustrated via the locking engagement of connector member 48 and connector member 56, those of ordinary skill in the art will readily appreciate that other mechanisms and/or fasteners may be utilized to attach engaging portion 20 and telescopable portion 19.

Turning next to engaging portion 20 and orthodontic implant 44, in addition to connector member 48, engaging portion 20 may include an orthodontic overcap 54, which is configured for coupling to an orthodontic implant such as orthodontic screw 44. Those of ordinary skill in the art may appreciate, however, that although engaging portion 20 is in the form of an orthodontic overcap 54, rotatably coupled to an orthodontic implant such as orthodontic screw 44, an orthodontic eyelet and the like may be utilized instead of an overcap.

Overcap 54 may be cylindrical in shape and include side walls 72, a cap 70, and an upper cavity 76 and a lower cavity 74 (shown in FIG. 2) for receiving orthodontic screw 44. Orthodontic screw 44 is shown having a cylindrical portion 58, a tapered shank 60 connected to the cylindrical portion 58, and a thread 62 disposed over the shank 60. Screw 44 also has a head 52 (shown in FIG. 2) and neck 50 (shown in FIG. 2). Those of ordinary skill will readily appreciate that other types of implants may be alternatively used.

Overcap 54 may be rotatably coupled to orthodontic screw 44. In particular, at least a portion of overcap 54 may rotate in a circular direction as generally depicted by arrows 82, around axis 78. By rotating overcap 54 of engaging portion 20, the telescoping portion 19 may be moved towards teeth 12 or away from teeth 12. Orthodontic screw 44 generally remains stationary during any movement.

As an example, a counterclockwise rotation of overcap 54 around axis 78 may cause pressure on connector member 56 which may then cause pressure on connector member 48 of piston housing 30 and cause the telescopable portion to move away from teeth 12. Conversely, a clockwise rotation of overcap 54 may result in a movement of telescopable portion 19 towards teeth 12. As crimpable portion 18 is attached to telescopable portion 19, crimpable portion 18 may also move in a manner similar to that of the telescopable portion 19. Rotation of the engaging portion 20, specifically the clockwise rotation, will be described further in connection with FIGS. 2A and 2B.

Gum line 88 in FIG. 1 generally illustrates the demarcation between the structures and portions of structures that are above a patient's gums and those that are below the gums. Crimpable portion 18, telescopable portion 19, wire 14, brackets 16 and 17, and engaging portion 20 will generally be above the gum line whereas only a portion of screw 44 and a portion of teeth 12 will be above the gum line. It is also worth noting that although crimpable portion 18, telescopable portion 19, and engaging portion 20 are illustrated in FIG. 1 and FIG. 2 as being coplanar, those of ordinary skill in the art will appreciate that other non-coplanar configurations are possible.

Turning now to FIG. 2, FIG. 2 illustrates a cross-sectional view of orthodontic system 10 with teeth 12 in phantom. Specifically, telescopable portion 19 and engaging portion 20 are shown in greater detail. Turning first to telescopable portion 19, the interior of piston housing 30 may contain a plurality of movement restricting members 36 and 38 to control the movement of piston rod 28 along axis 40. In operation, piston rod 28 contains a vertical member 32 to engage movement restricting member 36 and halt next to member 36 until sufficient force is applied to move both member 36 and vertical member 32 towards movement restricting member 38. Those of ordinary skill in the art will appreciate that the movement restricting members 36 and 38 are meant to provide tension within piston housing 30, akin to a spring, and serve as barriers to impede unrestricted movement along axis 40. Once sufficient force is supplied, vertical member 32 and member 36 will move along axis 40 and an additional portion of piston rod 28 may exist piston housing 30. Piston rod 28 may also move along axis 40 inwards, towards the end of cavity 31 closest to connector member 48, based upon the forces that are exerted.

Turning now to engaging portion 20 and orthodontic screw 44, overcap 54 also contains a cavity to permit engagement over and around at least a portion of orthodontic screw 44. Overcap 54 has a cap 70 and sidewalls 72. Upper cavity 76 generally contains head 52 of orthodontic screw 44 and the lower cavity 74 generally contains the neck of orthodontic screw 44. The lower cavity 74 also has a scalloped shape (shown in FIGS. 2A and 2B) to prevent unrestricted rotation of overcap 54 around axis 78.

Orthodontic screw 44 generally has a head 52 and an apple core shaped transition portion 50 of the neck that facilitates locking of ring 77 of overcap 54 with the apple core shaped transition portion 50 of orthodontic screw 44. Ring 77 engages portion 50 by friction. Additional details of overcap 54 are disclosed in co-pending PCT International application Ser. No. ______, filed on Oct. 10, 2007, entitled “Orthodontic Implant Cap and Orthodontic Treatment Assembly Including Same,” which is expressly incorporated by reference herein in its entirety.

Once in a locking engagement, at least a portion overcap 54 may be rotatably coupled to orthodontic screw 44 and may be rotated around axis 78. To rotate, a user may pull overcap 54 upwards, rotate the desired amount, and then push or release overcap 54 back into its place. As illustrated herein, generally all of overcap 54 rotates, but need not, consistent with the invention. Protrusions 86 may also emanate from orthodontic screw 44 to engage overcap 54 and prevent further insertion of screw 44 into overcap 54.

Turning to FIGS. 2A and 2B, FIG. 2A is generally an elevation view of engaging portion 20 of FIGS. 1 and 2 prior to a clockwise rotation of the overcap coupled to a screw and FIG. 2B is an elevation view of the engaging portion after the clockwise rotation of the overcap. In particular, the barrier created by the scalloped shape of cavity 74 may be overcome by lifting overcap 54, rotating overcap 54 clockwise past one or more scallops, and lowering the overcap 54 back in place. As screw 44 is implanted in a patient, it will remain stationary. Moreover, the clockwise rotation causes piston housing 30 to move towards the teeth and that inward movement is illustrated in FIG. 2B.

Those of ordinary skill in the art may appreciate that the size and/or shape of head 52 of screw 44 may be different from what is shown in other embodiments. For example, although the shape of the head is shown as elliptical, it may be triangular, etc., so long as it permits the engaging portion 20 to couple to screw 44 and/or rotatably couple to screw 44. Similarly, the shape of lower cavity 74, although shown as scalloped, may be shaped differently consistent with the present invention. Furthermore, although engaging portion 20 is depicted as an overcap 54, those of ordinary skill in the art may appreciate that other orthodontic devices (e.g., orthodontic eyelets) may be configured for coupling to an orthodontic implant and/or configured for rotatably coupling to an orthodontic implant.

To attach corrector assembly 8, described herein, a user may implant at least a portion of screw 44 below gum line 88 into the mouth in the desired location, attach at least one corrective device into the mouth, couple the engaging portion 20 to screw 44, and couple the crimpable portion 18 to wire 14. However, those of ordinary skill in the art will appreciate that various modifications may be made to this method. For example, the order in which each item is performed may be varied, the three portions of the corrector assembly may be attached to each other before execution of the items or they may be attached to each other during execution of the items or even after execution of the items, etc.

Those of ordinary skill in the art may appreciate that by having a telescopable portion, a crimpable portion, and an engaging portion, multiple modes of adjustability and direction of movement are possible. In particular, about three modes of adjustability may be achieved consistent with the present invention. Moreover, the present invention may be utilized as a Class II corrector for patients with Class II occlusions.

Those of ordinary skill in the art may also appreciate that the increased adjustability may allow a dental implant, such as an orthodontic screw, to be implanted into a patient's mouth in virtually any direction, including parallel to a tooth to prevent colliding of the screw with the root of the tooth. The corrector assembly may also exert pushing and pulling forces, and the corrector assembly, for example, may even be self guided within a patient's mouth depending upon the type of corrective device (e.g. wire) that is utilized.

While the present invention has been illustrated by a description of various preferred embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims.

What is claimed is:

1. A corrector assembly for applying a corrective force to a tooth, comprising:
a telescopable portion;
an attachable portion attached to the telescopable portion, wherein the attachable portion is configured for coupling to a corrective device; and
an engaging portion attached to the telescopable portion, wherein the engaging portion is configured for coupling to an orthodontic implant.

2. The corrector assembly of claim 1, wherein the telescopable portion is configured for pivotally coupling to the engaging portion.

3. The corrector assembly of claim 1, wherein at least a part of the attachable portion is selected from at least one of a wire or a spring.

4. The corrector assembly of claim 1, wherein at least a part of the attachable portion is a wire, the corrector assembly further comprising a head structure at a distal end of the wire configured for coupling to the corrective device.

5. The corrector assembly of claim 1, wherein the attachable portion is configured to telescope in response to an action causing the telescopable portion to telescope.

6. The corrector assembly of claim 1, wherein the corrective device is selected from at least one of a wire or a slot member.

7. The corrector assembly of claim 1, wherein the engaging portion is configured to be rotatably coupled to an orthodontic implant.

8. The corrector assembly of claim 1, wherein the engaging portion is selected from at least one of an orthodontic overcap or an orthodontic eyelet.

9. The corrector assembly of claim 1, wherein the orthodontic implant is an orthodontic screw.

10. An orthodontic assembly comprising:
an orthodontic implant; and
a corrector assembly for applying a corrective force to a tooth, wherein the corrector assembly includes a telescopable portion, an attachable portion attached to the telescopable portion, wherein the attachable portion is configured for coupling to a corrective device, and an engaging portion attached to the telescopable portion, wherein the engaging portion is coupled to the orthodontic implant.

11. The orthodontic assembly of claim 10, wherein the telescopable portion is configured for pivotally coupling to the engaging portion.

12. The orthodontic assembly of claim 10, wherein at least a part of the attachable portion is selected from at least one of a wire or a spring.

13. The orthodontic assembly of claim 10, wherein at least a part of the attachable portion is a wire, the corrector assembly further comprising a head structure at a distal end of the wire configured for coupling to the corrective device.

14. The orthodontic assembly of claim 10, wherein the corrective device is selected from at least one of a wire or a slot member.

15. The orthodontic assembly of claim 10, wherein the engaging portion is configured to be rotatably coupled to an orthodontic implant.

16. The orthodontic assembly of claim 10, wherein the engaging portion is selected from at least one of an orthodontic overcap or an orthodontic eyelet.

17. The orthodontic assembly of claim 10, wherein the orthodontic implant is an orthodontic screw.

18. An orthodontic system comprising:
a corrective device;
an orthodontic implant; and
a corrector assembly for applying a corrective force to a tooth, wherein the corrector assembly includes a telescopable portion, an attachable portion attached to the telescopable portion, wherein the attachable portion is coupled to the corrective device, and an engaging portion attached to the telescopable portion, wherein the engaging portion is coupled to the orthodontic implant.

19. The orthodontic system of claim 18, wherein the telescopable portion is configured for pivotally coupling to the engaging portion.

20. The orthodontic system of claim 18, wherein at least a part of the attachable portion is selected from at least one of a wire or a spring.

21. The orthodontic system of claim 18, wherein the corrective device is selected from at least one of a wire or a slot member.

22. The orthodontic system of claim 18, wherein the engaging portion is configured to be rotatably coupled to an orthodontic implant.

23. The orthodontic system of claim 18, wherein the engaging portion is selected from at least one of an orthodontic overcap or an orthodontic eyelet.

24. The orthodontic system of claim 18, wherein the orthodontic implant is an orthodontic screw.

25. A method of attaching a corrector assembly for applying a corrective force to a tooth, wherein the corrector assembly has a telescopable portion, an attachable portion configured to be attached to the telescopable portion, and an engaging portion configured to be attached to the telescopable portion, the method comprising:
implanting at least a portion of an orthodontic implant into a mouth,
attaching at least one corrective device into the mouth,
coupling the engaging portion to at least a portion of the orthodontic implant; and
coupling the attachable portion to the corrective device.

26. The corrector assembly of claim 1 wherein the attached portion is crimpable.

27. The orthodontic assembly of claim 11 wherein the attached portion is crimpable.

28. The orthodontic system of claim 20 wherein the attached portion is crimpable.
